(19) United States
(12) Patent Application Publication
(10) Pub. No.: US 2012/0284930 A1
(43) Pub. Date: Nov. 15, 2012

(54) AUTOMATIC REFRESH OF COMPLETED LOADS IN A WASHER OR DRYER APPLIANCE

(75) Inventors: Douglas Laurence Robertson, Crestwood, KY (US); Jonathan Blair Talmadge, Louisville, KY (US)

(73) Assignee: GENERAL ELECTRIC COMPANY, Schenectady, NY (US)

(21) Appl. No.: 13/104,318

(22) Filed: May 10, 2011

(51) Int. Cl. D06F 33/00; F26B 7/00

(52) U.S. Cl. 8/137; 68/12.02; 34/427

(57) ABSTRACT

Automatic refresh of a completed load of articles (e.g., laundry) left in a washing machine or dryer that has been idle for a period of time is provided. After a certain amount of time has elapsed following completion of a laundry cycle, the laundry is refreshed by restarting the appliance. All or a portion of a cycle of the appliance may be repeated in order to refresh the articles. User adjustable options can be provided for e.g., the length of the idle time, when the refresh is executed, and other options as well.

### FIELD OF THE INVENTION

The present invention relates to the automatic refresh of a completed load of articles (e.g., laundry) left in a washing machine or dryer that has been idle for a period of time.

### BACKGROUND OF THE INVENTION

Modern washing machines and clothes dryers typically operate on cycles that can be selected and/or activated through a user interface positioned e.g., on a backsplash of the appliance. The user interface may consist of traditional dials and/or push buttons and/or it may include a touch screen type of device that is sensitive to contact. Typically, the user interface can be used to select among various options for operation of the appliance. For example, a washing machine may include a “normal” cycle as well as a “delicates” cycle with options for different wash load sizes. A dryer may include different heat settings and time periods for operation.

Normally, once the user loads articles into the machine, selects the desired options, and activates the appliance, the appliance will execute a laundry cycle according to the options selected. Laundry cycles can vary in length of time but eventually the cycle is completed and the articles are ready to be removed from the appliance. The appliance may include a signal device, such as a bell or buzzer, for providing an audible alert to the user that that the laundry cycle has been completed.

Frequently, a user is not immediately available to unload the appliance by removing the articles at the end of the laundry cycle. Due to the time required to compete the laundry cycle, the user may e.g., become involved in other activities or simply fail to hear the alert and/or forget about the presence of articles in the appliance. As such, conventionally the appliance simply remains idle for the period of time between the end of the laundry cycle and the time when the user returns to unload the appliance.

If the amount of time during which the appliance remains idle with a completed load is relatively short, then there may be no negative effects on the articles in the appliance. On the other hand, if the idle time is relatively long, the articles in the appliance may be negatively impacted. For example, if the appliance is a washing machine and the idle time is prolonged, the clothes may mildew due to the moisture remaining in and/or on the articles after the laundry cycle is completed. If the appliance is a dryer, then articles such as clothing or linens may become more wrinkled particularly as the length of the idle time increases.

Upon discovery of the loaded appliance after a significant idle time, the user may elect to re-start the appliance in order to refresh the articles—i.e. remove the negative effects on the articles by repeating all or part of a laundry cycle. For example, for the washing machine with mildewed articles, the user may have to rewash the articles. With a dryer, the user may find a need to re-start a drying cycle in order to remove the wrinkles.

Accordingly, an appliance that can refresh a load of articles for which a laundry cycle has been completed would be useful. More specifically, an appliance that will automatically refresh a load of articles after the appliance has been idle for a predetermined period of time would be helpful. Such an appliance that can be provided with various options for the execution of such refresh would also be beneficial.

### BRIEF DESCRIPTION OF THE INVENTION

Aspects and advantages of the invention will be set forth in part in the following description, or may be obvious from the description, or may be learned through practice of the invention.

In one exemplary aspect, the present invention provides a method of operating an appliance that includes the steps of initiating a timer, if the appliance is idle, so as to measure an elapsed amount of time, T_{IDLE}, during which the appliance is idle; ascertaining whether T_{IDLE} is equal to or greater than a predetermined amount of time, T_{MAX}; and, refreshing a load of articles in the appliance if the amount of elapsed time T_{IDLE} equals or exceeds a predetermined amount of time, T_{MAX}.

In another exemplary embodiment, the present invention provides an appliance for the treatment of articles. The appliance includes a wash tub for the receipt of the articles; a user interface whereby the user may operate the appliance; a motor for operating the appliance; and, at least one processing device in communication with the user interface and the motor. The at least one processing device is configured for initiating a timer, if the appliance is idle, so as to measure an elapsed amount of time, T_{IDLE}, during which the appliance is idle; ascertaining whether T_{IDLE} is equal to or greater than a predetermined amount of time, T_{MAX}; and, refreshing a load of articles in the appliance if the amount of elapsed time T_{IDLE} exceeds a predetermined amount of time, T_{MAX}.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of an exemplary embodiment of an appliance of the present invention. Although a washing machine is shown, a laundry dryer may also be used with the present invention as well.

FIG. 2 provides a front, cross-sectional view of the exemplary embodiment of FIG. 1.

FIG. 3 is a flowchart illustrating an exemplary method of the present invention.

FIG. 4 illustrates exemplary user prompts as may be used with the present invention.

### DETAILED DESCRIPTION OF THE INVENTION

The present invention relates to the automatic refresh of a completed load of articles (e.g., laundry) left in a washing machine or dryer that has been idle for a period of time. After a certain amount of time has elapsed following completion of a laundry cycle, the laundry is refreshed by restarting the appliance. All or a portion of a cycle of the appliance may be repeated in order to refresh the articles. User adjustable options can be provided for e.g., the length of the idle time, when the refresh is executed, and other options as well. Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “article” may refer to but need not be limited to fabrics, textiles, garments (or clothing), and linens. Furthermore, the term “load” or “laundry load” refers to the combination of articles that may be washed together in a washing machine or dried together in a laundry dryer (i.e. clothes dryer) and may include a mixture of different or similar articles of different or similar types and kinds of fabrics, textiles, garments and linens within a particular laundering process.

The term “wash cycle” is intended to refer to one or more periods of time, in which a washing machine that contains the articles to be laundered operates using a detergent and water, preferably with agitation to e.g., remove dirt and odors from the articles. The term “rinse cycle” is intended to refer to one or more periods of time in which the washing machine operates to remove residual detergents that were retained by the articles after completion of the wash cycle. The term “first rinse cycle” refers to the first cycle after a wash cycle, wherein water (fresh water or a rinse fluid) is added in order to help remove detergent from the articles. The term “spin cycle” is intended to refer to one or more periods of time during which the washing machine rotates the articles so as to create centrifugal forces to remove water, typically grey water or effluent, from the article after a wash or rinse cycle. The term “drying cycle” refers to any period of time during which a laundry dryer is operated. As such, “drying cycle” includes a period of time that is preset by the laundry dryer as well as a period of time randomly selected.

As used herein, the term “laundry cycle” refers to the operation of laundry appliance including a washing machine or a laundry dryer. Accordingly, “laundry cycle” for a washing machine can include a wash cycle, rinse cycle, and/or spin cycle, and can include multiple such cycles in various combinations. For a dryer, “laundry cycle” can include operation for various periods of time and/or with different levels of heat. “Refresh” or “refreshing a load of articles” as used herein refers to the operation of the appliance (washing machine or laundry dryer) after the appliance has remained idle for a period of time following completion of a laundry cycle with an article or a load of articles that was not removed from the appliance during the idle period.

In the description that follows, an exemplary embodiment of a washing machine is used by way of example in describing the present invention. However, as will be understood by one of skill in the art using the teachings disclosed herein, the present invention may be used with a laundry dryer (i.e., clothes dryer) as well. Accordingly, the present invention is applicable to either appliance type as set forth in the claims that follow.

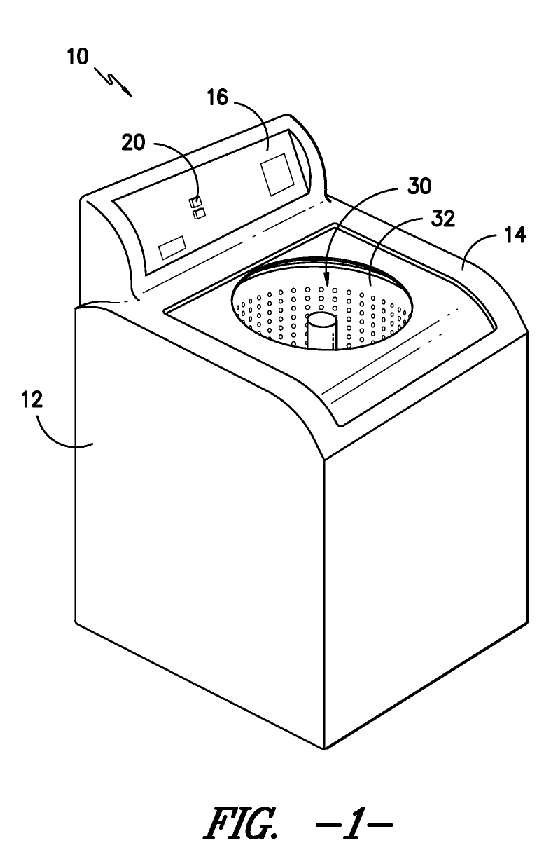

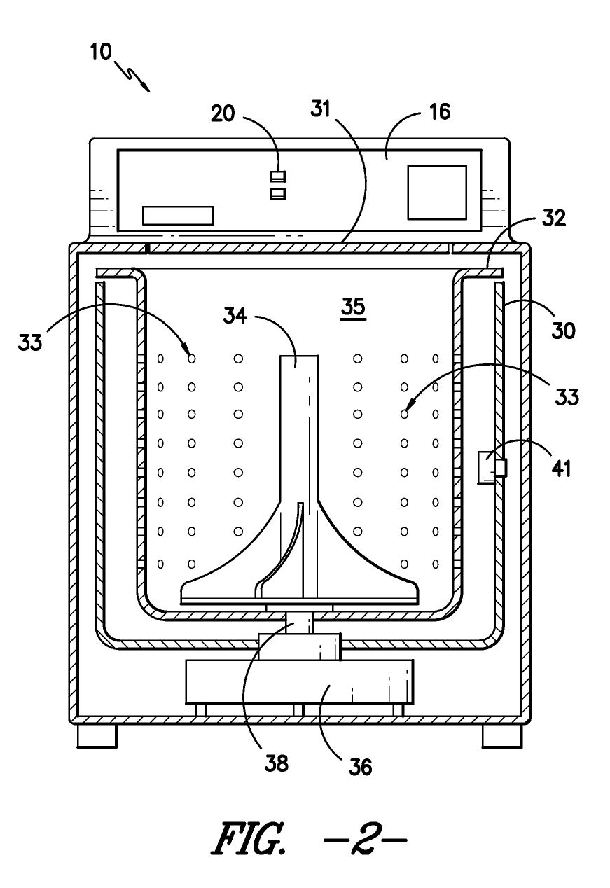

FIG. 1 is a perspective view of an exemplary vertical axis washing machine 10 that includes a cabinet 12 having a cover 14. FIG. 2 provides a cross-sectional view of the machine 10 of FIG. 1. A backsplash 16 extends from cover 14 and a variety of appliance control input selectors 20 are coupled to backsplash 16. Input selectors 20 form a user interface for operator/user selection of washing cycles and features. For clarity of illustration, a door 31 is not shown in FIG. 1 so that the interior of machine 10 is visible—door 31 is shown in cross-section in FIG. 2.

A wash tub 30 is located within cabinet 12, and a wash basket 32 is rotatably mounted within wash tub 30 in a spaced apart relationship from wash tub 30. Basket 32 includes a plurality of perforations 33 therein to facilitate fluid communication between the interior 35 of basket 32 and wash tub 30. An agitator, impeller, or oscillatory basket mechanism 34 is disposed in basket 32 to impart an oscillatory motion to articles and liquid in basket 32. Agitator 34 is provided by way of example only; other configurations for agitation may be used including e.g., fins on basket 32 or other configurations as well. Motor 36 provides for the movement of agitator 34 through connection by shaft 38. Wash tub 30 is also in fluid communication with one or more pumps and/or drains for the removal of water, such as grey water, from wash tub 30 such as e.g., after a wash or rinse cycle. One or more sensors 41 can be included in wash tub 30 for determining e.g., the temperature of the water, the presence of surfactants, or other measurements as well.

Washing machine 10 is controlled by a processing device or other controller, such as a microprocessor (not shown), according to user preference via manipulation of control input selectors 20 mounted on backsplash 16. As used herein, processing device may refer to one or more microprocessors or semiconductor devices and is not restricted necessarily to a single element. The processing device can be programmed to operate washing machine 10 according to the exemplary aspects of the present invention as set forth below. The processing device may include, or be associated with, one or memory elements such as e.g., electrically erasable, programmable read only memory (EEPROM).

As illustrated in FIG. 1, agitator 34 is oriented to rotate about a vertical axis. It is contemplated, however, that benefits of the present invention can apply to horizontal axis washing machines as well. More specifically, the washing machine of FIGS. 1 and 2 is provided by way of example only. Using the teachings disclosed herein, one of ordinary skill in the art will understand the present invention may be used with washing machines and laundry dryers of various other configurations in both residential and commercial applications.

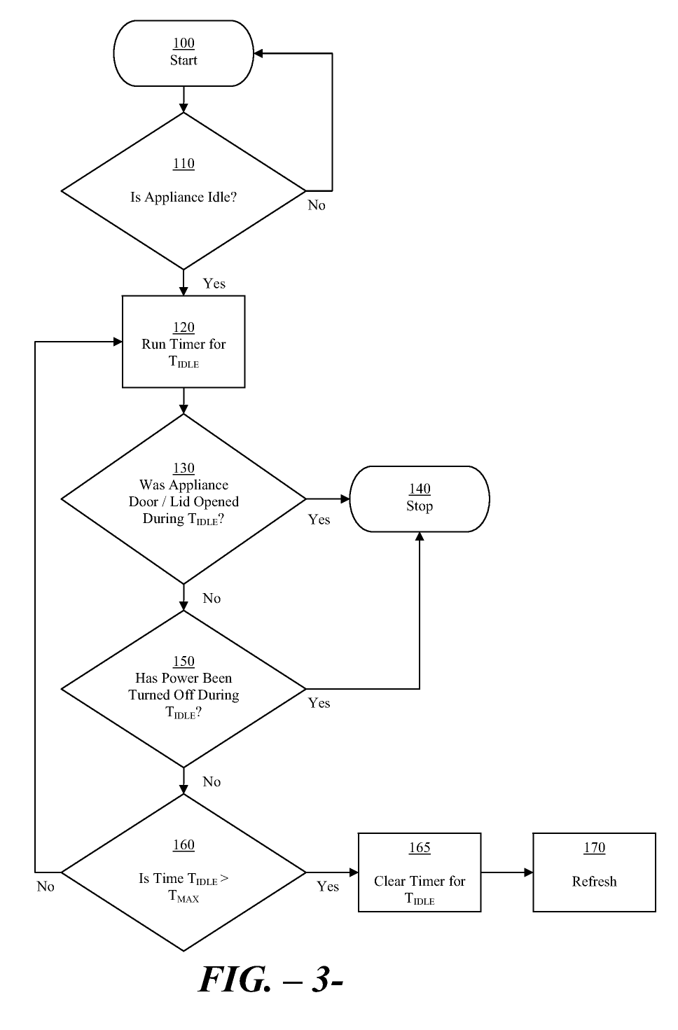

Using a flowchart, FIG. 3 illustrates an exemplary method of operation of the present invention. More particularly, an exemplary method for refreshing a load of articles in an appliance is shown. For example, the processing device of washing machine 10 may be equipped to operate machine 10 as set forth in FIG. 3 or with variations thereof.

From start 100, a determination is made in step 110 regarding whether the appliance e.g., washing machine 10—is idle. If washing machine 10 is still executing a laundry cycle, for example, then the processing device determines that machine is not idle. Accordingly, a refresh of the laundry articles is not necessary. However, if the washing machine 10 is not executing a laundry cycle, then the processing device proceeds to the next step.

In step 120, a timer is initiated because washing machine 10 is in an idle state. The timer measures the time that has elapsed, T_{IDLE}, since the determination in step 100 that the appliance was idle—i.e. not executing a laundry cycle including any portion thereof. By way of example, the processing device can be programmed to initiate the timer upon completion of a laundry cycle such that determination in step 110 that machine 10 is idle is automatic at the end of the laundry cycle.

While in step 120 the timer is running to calculate T_{IDLE}, various events can occur for which the processing device assumes that the load of articles in washing machine 10 has been removed and a refresh is no longer necessary. Accordingly, while the timer for T_{IDLE} is running, the processing device determines whether door 31 on washing machine 10 has been opened. For example, door 31 can be equipped with a sensor that signals the processing device if door 31 is lifted. Upon determining that door 31 has been opened in step 130, it is assumed that the user has removed the load of articles. In such case, a refresh is no longer necessary and the timer is stopped in step 140.

Similarly, if power to washing machine 10 is turned off, then it is again assumed that the load of articles has been removed. For example, a power failure may occur. As such, upon powering up, the processing device will assume that there is no load of articles in washing machine 10. Alternatively, the user may turn off power to washing machine 10 and, again, the processing device will assume that the load of articles has been removed once washing machine 10 is powered up. Regardless, if it is determined in step 150 that the power has been turned off since the last laundry cycle, then the timer is stopped.

Alternatively, if power has not been turned off and the door to washing machine 10 has not been opened, then the timer continues to measure the elapsed idle time T_{IDLE}. In step 160, the processing device determines whether the elapsed time T_{IDLE} equals and/or exceeds a certain predetermined amount of time T_{MAX}. As used herein, T_{MAX} represents the amount of time for which washing machine 10 will be allowed to remain idle with a load of articles present for which a laundry cycle has been operated. For example, in the case of washing machine 10, T_{MAX} is predetermined amount of time for which a wet load of articles will be allowed to remain in basket 32 while machine 10 is idle. In the case of a clothes dryer, for example, T_{MAX} is the amount of time a dried (or partially dried) load of articles will be allowed to remain in the dryer while it is idle.

Continuing with step 160, until the elapsed time meets and/or exceeds T_{MAX}, the timer simply continues to measure T_{IDLE} while the processing device monitors for either a power disruption or the opening of door 31. As previously described, either event will stop the timer. Assuming neither of these events occurs, eventually the amount of elapsed time for which the appliance is idle, T_{IDLE}, will eventually meet and/or exceed T_{MAX}. In such case, the processing device clears the timer for T_{IDLE} in step 165 and executes a refresh of the load of articles in step 170. As previously indicated, in the case of washing machine 10, such refresh may include a full laundry cycle that includes a wash cycle, rinse cycles, and/or spin cycles. Alternatively, for example, only a rinse and spin cycle may be operated. Other variations may be used as well. In the case of a dryer, the processing device may restart an entire drying cycle or may be programmed to operate the clothes dryer for a predetermined period of time and heat—such as e.g., a 10 minute “fluff” cycle. Other variations may be used as well.

FIG. 3 is provided by way of example only. Using the teachings disclosed herein, one of skill in the art will understand that other methods for conducting a refresh of a load of articles in an appliance may also be applied. Different steps or a different ordering of the steps shown in FIG. 3 may be used. For example, the timer may be initiated only after the processing device determines that a door has not been opened and/or a power loss has not occurred. Other variations may be used as well.

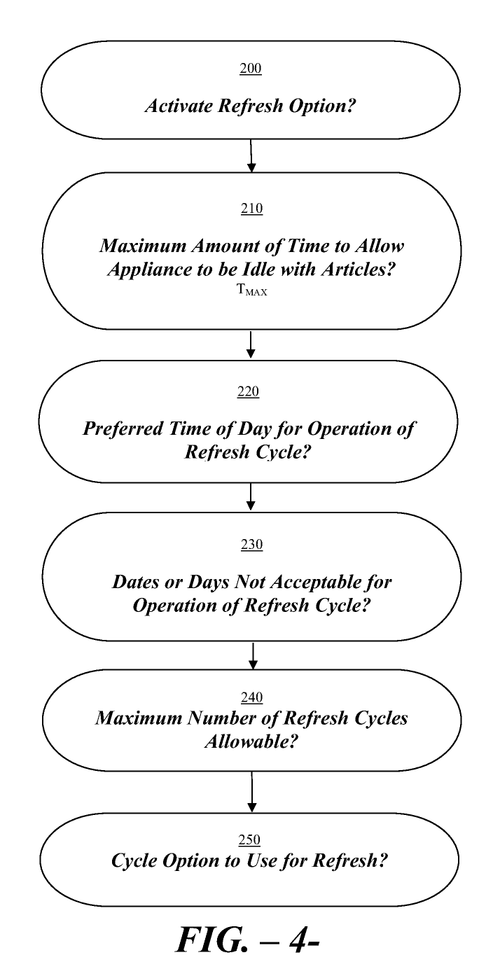

The present invention can also allow the user to customize various options for a refresh of the load of articles in an appliance. FIG. 4 provides an illustration of exemplary prompts that an appliance might provide (e.g., through proper configuration of the processing device) through e.g., a touch display on a user interface. In prompt 200, the user is asked whether or not to activate the refresh option. Assuming the user responds affirmatively, prompt 210 then requests that the user identify the amount of time T_{MAX} for which the appliance will be allowed to remain idle with a load of clothes. This amount may be arbitrarily chosen by the user such as e.g., 3 hours. Alternatively, prompt 210 may provides suggestions for selection by the user such as e.g., 3, 6, or 8 hours.

Prompt 220 inquires into whether the user has a preferred time of day of executing a refresh. For example, the user may prefer such occurs during night time or sleeping hours where rates for electricity consumption may be less. As such, the user might respond with e.g., “between 1 AM and 5 AM.” Alternatively, the user may be concerned about noise from machine operation during sleeping hours and may choose some other convenient time period such as ‘between 6 PM and 11 PM.” Other times may be allowed as well.

With prompt 230, the user is allowed to determine days or dates on which a refresh will not be allowed. For example, the user may not want the appliance to operate on a Sunday/Sabbath day. Certain holiday/vacation days such as e.g., New Years Day, Thanksgiving, and/or Christmas might also be excluded. Accordingly, prompt 230 allows the user to customize the refresh and block certain days or dates from use.

The user may also want to limit the number of refresh cycles that will be conducted. Accordingly, prompt 240 allows the user to choose a limit on the number of refresh cycles. For example, the user might enter an integer between 1 and 3.

Prompt 250 allows further customization of the refresh by allowing the user to select what cycle (or portion thereof) will be used for the refresh. For example, in the case of washing machine 10, the user might select an entire laundry cycle or just rinse and spin cycles. For a clothes dryer, the user might choose a complete cycle such as “delicates” cycle, of the user might enter the amount of time (e.g., 20 minutes) and the level of heat (high, medium, or low) to use during refresh. Other variations may also be applied.

FIG. 4 is provided by way of example only. Other prompts and/or a different ordering of the prompts may also be applied.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating an appliance, comprising the steps of:
initiating a timer, if the appliance is idle, so as to measure an elapsed amount of time, T_{IDLE}, during which the appliance is idle;
ascertaining whether T_{IDLE} is equal to or greater than a predetermined amount of time, T_{MAX}; and,
refreshing a load of articles in the appliance if the amount of elapsed time T_{IDLE} equals or exceeds a predetermined amount of time, T_{MAX}.

2. A method of operating an appliance as in claim 1, further comprising the step of determining whether the appliance is idle.

3. A method of operating an appliance as in claim 2, wherein said determining step comprises confirming that a laundry cycle for a load of articles in the appliance has been completed.

4. A method of operating an appliance as in claim 1, wherein said step of initiating a timer is executed at or after completion of a laundry cycle for a load of articles in the appliance.

5. A method of operating an appliance as in claim 1, wherein the predetermined amount of time, T_{MAX}, is selected by a user of the appliance.

6. A method of operating an appliance as in claim 1, wherein the timer is stopped if a door for removing articles from the appliance is opened.

7. A method of operating an appliance as in claim 1, wherein the timer is stopped if the appliance is turned off or a power loss occurs.

8. A method of operating an appliance as in claim 1, wherein the appliance is a washing machine and said step of refreshing comprises repeating a laundry cycle that comprises a wash cycle and a rinse cycle.

9. A method of operating an appliance as in claim 1, wherein the appliance is a washing machine and said step of refreshing comprises repeating a rinse cycle.

10. A method of operating an appliance as in claim 1, wherein the appliance is a dryer and said step of refreshing comprises repeating a drying cycle.

11. A method of operating an appliance as in claim 1, wherein the appliance is a dryer and step of refreshing comprises operating the dryer for a predetermined period of time.

12. A method of operating an appliance as in claim 1, wherein said step of refreshing is executed only during certain times of the day as determined by a user.

13. A method of operating an appliance as in claim 1, wherein said step of refreshing is prevented from executing during certain days of the week as determined by a user.

14. A method of operating an appliance as in claim 1, wherein said step of refreshing is prevented from executing during certain dates of the year as determined by a user.

15. An appliance for the treatment of articles, comprising:
a wash tub for the receipt of the articles;
a user interface whereby the user may operate the appliance;
a motor for operating the appliance; and,
at least one processing device in communication with said user interface and said motor, said at least one processing device configured for:
initiating a timer, if the appliance is idle, so as to measure an elapsed amount of time, T_{IDLE}, during which the appliance is idle;
ascertaining whether T_{IDLE} is equal to or greater than a predetermined amount of time, T_{MAX}; and,
refreshing a load of articles in the appliance if the amount of elapsed time T_{IDLE} exceeds a predetermined amount of time, T_{MAX}.

16. An appliance for the treatment of articles as in claim 15, wherein said at least one processing device is further configured for stopping the timer if a door for removing articles from the appliance is opened.

17. An appliance for the treatment of articles as in claim 15, wherein said at least one processing device is further configured for stopping the timer if the appliance is turned off or a power loss occurs.

18. An appliance for the treatment of articles as in claim 15, wherein the appliance is a washing machine and said at least one processing device is further configured for refreshing the articles by repeating a laundry cycle that comprises a wash cycle and a rinse cycle.

19. An appliance for the treatment of articles as in claim 15, wherein the appliance is a dryer and said at least one processing device is further configured for refreshing the articles by operating the dryer for a predetermined period of time.
